(19) United States
(12) Patent Application Publication
(10) Pub. No.: US 2025/0119316 A1
(43) Pub. Date: Apr. 10, 2025

(54) RELAY DEVICE, RELAY SYSTEM, RELAY METHOD, AND COMPUTER PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Takuya KOBAYASHI, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/832,011

(22) PCT Filed: Jan. 10, 2023
(86) PCT No.: PCT/JP2023/000313

§ 371 Date: Jul. 22, 2024

(30) Foreign Application Priority Data
Jan. 27, 2022 (JP) 2022-011135

(51) Int. Cl. H04L 12/46; H04W 52/02

(52) U.S. Cl. CPC H04L 12/46; H04W 52/0261

(57) ABSTRACT

A relay device is arranged as a node on a communication line connected to a first ECU connected to a plurality of second ECUs. A first PHY unit switches a third ECU from a sleep mode to a normal mode when receiving a broadcasted control message addressed to the third ECU. The second ECUs also include a fourth ECU provided with a second PHY unit that switches the fourth ECU to the normal mode in a case where a control message is received. In the case where a first control message, addressed to a second ECU, is received from a first region, the relay device relays the first control message, in a case where a second control message, not addressed to a second ECU, is received from the first region, the relay device does not relay the second control message.

### CROSS-REFERENCE TO RELATED APPLICATIONS

This application is the U.S. national stage of PCT/JP2023/000313 filed on Jan. 10, 2023, which claims priority of Japanese Patent Application No. JP 2022-011135 filed on Jan. 27, 2022, the contents of which are incorporated herein.

### TECHNICAL FIELD

The present disclosure relates to a relay device, a relay system, a relay method, and a computer program.

### BACKGROUND

In-vehicle networks in which multiple electronic control units (ECUs) are connected are known. The number of ECUs installed in vehicles has increased in recent years, and in order to reduce the overall power consumption of a system, a partial network function has been developed so as to wake up only the ECUs used for control and set the other ECUs to a sleep state.

As an example of a technology for waking up a sleeping ECU when an abnormality occurs in communication, JP 2015-107672A discloses an ECU that normally receives a wake-up signal via a communication path, but when an abnormality occurs in communication, receives an activation pulse signal transmitted from a management ECU to the ECU via a power supply path.

Each ECU has a PHY (Physical Layer) for connecting to a communication line. A PHY may be a supporting PHY that supports the partial network function, or a non-supporting PHY that does not support the partial network function.

A supporting PHY wakes up the ECU upon selectively receiving a control message addressed to the corresponding ECU among control messages broadcast on a communication line. On the other hand, a non-supporting PHY wakes up the ECU upon receiving any control message broadcast on the communication line regardless of the destination of the message. In this way, an ECU that includes a non-supporting PHY may wake up and consume power even if the ECU not used for control.

For this reason, conventionally, when the partial network function is to be used, a supporting PHY has been installed in every ECU, for example, and the cost of implementing the partial network function has increased with the increasing number of ECUs. Furthermore, if an ECU provided with a non-supporting PHY is used in conjunction in order to reduce the cost of implementing supporting PHYs, there is a problem that the overall power consumption of the system will increase, as described above.

In view of such problems, an object of the present disclosure is to provide a relay device, a relay system, a relay method, and a computer program that enable more favorably using an ECU provided with a PHY that supports the partial network function in conjunction with an ECU provided with a PHY that does not support the partial network function.

### SUMMARY

A relay device according to an aspect of the present disclosure is a relay device to be provided in a vehicle and arranged as a node on a communication line connected to a first ECU provided in the vehicle, the first ECU being bus-connected to a plurality of second ECUs via the communication line, the communication line having a first region on a side of the relay device corresponding to the first ECU, and a second region on a side of the relay device opposite to the first ECU, each of the second ECUs being switchable, based on a control message broadcast to the communication line, from a sleep mode to a normal mode, the sleep mode being a mode in which functionality is restricted to achieve lower power consumption than in the normal mode, the second ECUs including a third ECU including a first PHY unit configured to switch the third ECU from the sleep mode to the normal mode in a case of receiving a control message addressed to the third ECU, and to not switch the third ECU from the sleep mode to the normal mode in a case of receiving a control message not addressed to the third ECU, and a fourth ECU including a second PHY unit configured to switch the fourth ECU from the sleep mode to the normal mode in a case of receiving a control message regardless of a destination of the received control message, at least one third ECU being connected to the first region, at least one fourth ECU being connected to the second region, the relay device being configured to, in a case where a first control message, which is a control message addressed to the second ECU connected to the second region, is transmitted from the first region to the relay device, relay the first control message to the second region, and the relay device being further configured to, in a case where a second control message, which is a control message not addressed to the second ECU connected to the second region, is transmitted from the first region to the relay device, not relay the second control message to the second region.

A relay method according to an aspect of the present disclosure is a relay method in a relay device to be provided in a vehicle and arranged as a node on a communication line connected to a first ECU provided in the vehicle, the first ECU being bus-connected to a plurality of second ECUs via the communication line, the communication line having a first region on a side of the relay device corresponding to the first ECU, and a second region on a side of the relay device opposite to the first ECU, each of the second ECUs being switchable, based on a control message broadcast to the communication line, from a sleep mode to a normal mode, the sleep mode being a mode in which functionality is restricted to achieve lower power consumption than in the normal mode, the second ECUs including a third ECU including a first PHY unit configured to switch the third ECU from the sleep mode to the normal mode in a case of receiving a control message addressed to the third ECU, and to not switch the third ECU from the sleep mode to the normal mode in a case of receiving a control message not addressed to the third ECU, and a fourth ECU including a second PHY unit configured to switch the corresponding fourth ECU from the sleep mode to the normal mode in a case of receiving a control message regardless of a destination of the received control message, at least one third ECU being connected to the first region, and at least one fourth ECU being connected to the second region, the relay method including: a first step of, in a case where a first control message, which is a control message addressed to the second ECU connected to the second region, is transmitted from the first region to the relay device, relaying the first control message to the second region; and a second step of, in a case where a second control message, which is a control message not addressed to the second ECU connected to the second region, is transmitted from the first region to the relay device, not relaying the second control message to the second region.

A computer program according to an aspect of the present disclosure is a computer program for relaying performed by a relay device to be provided in a vehicle and arranged as a node on a communication line connected to a first ECU provided in the vehicle, the first ECU being bus-connected to a plurality of second ECUs via the communication line, the communication line having a first region on a side of the relay device corresponding to the first ECU, and a second region on a side of the relay device opposite to the first ECU, each of the second ECUs being switchable, based on a control message broadcast to the communication line, from a sleep mode to a normal mode, the sleep mode being a mode in which functionality is restricted to achieve lower power consumption than in the normal mode, the second ECUs including a third ECU including a first PHY unit configured to switch the third ECU from the sleep mode to the normal mode in a case of receiving a control message addressed to the third ECU, and to not switch the third ECU from the sleep mode to the normal mode in a case of receiving a control message not addressed to the third ECU, and a fourth ECU including a second PHY unit configured to switch the corresponding fourth ECU from the sleep mode to the normal mode in a case of receiving a control message regardless of a destination of the received control message, at least one third ECU being connected to the first region, and at least one fourth ECU being connected to the second region, the computer program causing a computer to execute: a first step of, in a case where a first control message, which is a control message addressed to the second ECU connected to the second region, is transmitted from the first region to the relay device, relaying the first control message to the second region; and a second step of, in a case where a second control message, which is a control message not addressed to the second ECU connected to the second region, is transmitted from the first region to the relay device, not relaying the second control message to the second region.

### Advantageous Effects

According to the present disclosure, it is possible to more favorably use an ECU provided with a PHY that supports the partial network function in conjunction with an ECU provided with a PHY that does not support the partial network function.

### BRIEF DESCRIPTION OF DRAWINGS

FIG. 1 is a diagram illustrating an example of a relay system according to an embodiment.

FIG. 2 is a diagram illustrating an example of the internal configuration of the relay device according to the embodiment.

FIG. 3 is a diagram illustrating an example of the internal configuration of a first ECU according to the embodiment.

FIG. 4 is a flowchart illustrating an example of a relay method according to the embodiment.

FIG. 5 is a schematic diagram illustrating the relay method according to the embodiment.

FIG. 6 is a schematic diagram illustrating the relay method according to the embodiment.

FIG. 7 is a schematic diagram illustrating the relay method according to the embodiment.

FIG. 8 is a schematic diagram illustrating the relay method according to the embodiment.

FIG. 9 is a diagram illustrating a relay device according to a modified example.

FIG. 10 is a diagram for describing an arrangement of relay devices according to a modified example.

### DETAILED DESCRIPTION OF PREFERRED EMBODIMENTS

The gist of the present disclosure includes configurations described below.

A relay device according to an aspect of the present disclosure is a relay device to be provided in a vehicle and arranged as a node on a communication line connected to a first ECU provided in the vehicle, the first ECU being bus-connected to a plurality of second ECUs via the communication line, the communication line having a first region on a side of the relay device corresponding to the first ECU, and a second region on a side of the relay device opposite to the first ECU, each of the second ECUs being switchable, based on a control message broadcast to the communication line, from a sleep mode to a normal mode, the sleep mode being a mode in which functionality is restricted to achieve lower power consumption than in the normal mode, the second ECUs including a third ECU including a first PHY unit configured to switch the third ECU from the sleep mode to the normal mode in a case of receiving a control message addressed to the third ECU, and to not switch the third ECU from the sleep mode to the normal mode in a case of receiving a control message not addressed to the third ECU, and a fourth ECU including a second PHY unit configured to switch the fourth ECU from the sleep mode to the normal mode in a case of receiving a control message regardless of a destination of the received control message, at least one third ECU being connected to the first region, at least one fourth ECU being connected to the second region, the relay device being configured to, in a case where a first control message, which is a control message addressed to the second ECU connected to the second region, is transmitted from the first region to the relay device, relay the first control message to the second region, and the relay device being further configured to, in a case where a second control message, which is a control message not addressed to the second ECU connected to the second region, is transmitted from the first region to the relay device, not relay the second control message to the second region.

According to this configuration, even if the second region includes the fourth ECU that wakes up regardless of the destination of the control message, the relay device can selectively block that control message so as to not be received by the fourth ECU, thus making it possible to suppress an increase in power consumption caused by the fourth ECU waking up. Furthermore, by using the fourth ECU in conjunction with the third ECU, the implementation cost of the relay system can be reduced. As a result, in the relay system, the third ECU and the fourth ECU can be used in conjunction more favorably.

A configuration is possible in which the relay device includes a control unit configured to determine whether or not a control message transmitted from the first region to the relay device is the first control message, and, in a case where the control message transmitted from the first region is the first control message, relay the first control message to the second region.

In this case, the control unit determines whether or not the received control message is a first control message, thus making it possible to simplify the configuration of the PHY unit of the relay device. This makes it possible to reduce the implementation cost of the relay device.

A configuration is possible in which the relay device includes a third PHY unit configured to receive a control message transmitted from the first region to the relay device; and a control unit configured to relay the control message output from the third PHY unit to the second region, wherein the third PHY unit outputs the first control message to the control unit, and does not output the second control message to the control unit.

In this case, the third PHY unit determines whether or not the received control message is a first control message, thus making it possible to reduce the processing load on the control unit. As a result, the control unit can have a more simple configuration, and the implementation cost of the relay device can be reduced.

A configuration is possible in which the control unit is further configured to switch between a supply state in which power is supplied to a hardware device connected to the relay device via a power supply line, and a stopped state in which supply of power to the hardware device is stopped, the hardware device is connected to the second ECU connected to the second region, and the control unit switches from the stopped state to the supply state in a case where a first control message addressed to the second ECU connected to the hardware device is transmitted from the first region to the relay device.

According to this configuration, it is possible to suppress power consumption in the hardware device.

A configuration is possible in which the relay device is a non-branching node not branching the communication line.

According to this configuration, data relay control can be performed easily in the relay device, and the configurations of units of the relay device can be simplified. This makes it possible to reduce the implementation cost of the relay device and suppress power consumption in the relay device.

A configuration is possible in which the relay device is housed in a junction box.

According to this configuration, it is possible to save space when installing the relay device. Furthermore, there is no need to separately prepare a casing for housing the relay device, and thus the implementation cost of the relay device can be reduced.

A relay system according to an aspect of the present disclosure is a relay system including the relay device according to any of (1) to (6), the first ECU, and the communication line.

A relay method according to an aspect of the present disclosure is a relay method in a relay device to be provided in a vehicle and arranged as a node on a communication line connected to a first ECU provided in the vehicle, the first ECU being bus-connected to a plurality of second ECUs via the communication line, the communication line having a first region on a side of the relay device corresponding to the first ECU, and a second region on a side of the relay device opposite to the first ECU, each of the second ECUs being switchable, based on a control message broadcast to the communication line, from a sleep mode to a normal mode, the sleep mode being a mode in which functionality is restricted to achieve lower power consumption than in the normal mode, the second ECUs including a third ECU including a first PHY unit configured to switch the third ECU from the sleep mode to the normal mode in a case of receiving a control message addressed to the third ECU, and to not switch the third ECU from the sleep mode to the normal mode in a case of receiving a control message not addressed to the third ECU, and a fourth ECU including a second PHY unit configured to switch the corresponding fourth ECU from the sleep mode to the normal mode in a case of receiving a control message regardless of a destination of the received control message, at least one third ECU being connected to the first region, and at least one fourth ECU being connected to the second region, the relay method including: a first step of, in a case where a first control message, which is a control message addressed to the second ECU connected to the second region, is transmitted from the first region to the relay device, relaying the first control message to the second region; and a second step of, in a case where a second control message, which is a control message not addressed to the second ECU connected to the second region, is transmitted from the first region to the relay device, not relaying the second control message to the second region.

According to this configuration, even if the second region includes the fourth ECU that wakes up regardless of the destination of the control message, the relay device can selectively block that control message so as to not be received by the fourth ECU, thus making it possible to suppress an increase in power consumption caused by the fourth ECU waking up. Furthermore, by using the fourth ECU in conjunction with the third ECU, the implementation cost of the relay system can be reduced. As a result, in the relay system, the third ECU and the fourth ECU can be used in conjunction more favorably.

A computer program according to an aspect of the present disclosure is a computer program for relaying performed by a relay device to be provided in a vehicle and arranged as a node on a communication line connected to a first ECU provided in the vehicle, the first ECU being bus-connected to a plurality of second ECUs via the communication line, the communication line having a first region on a side of the relay device corresponding to the first ECU, and a second region on a side of the relay device opposite to the first ECU, each of the second ECUs being switchable, based on a control message broadcast to the communication line, from a sleep mode to a normal mode, the sleep mode being a mode in which functionality is restricted to achieve lower power consumption than in the normal mode, the second ECUs including a third ECU including a first PHY unit configured to switch the third ECU from the sleep mode to the normal mode in a case of receiving a control message addressed to the third ECU, and to not switch the third ECU from the sleep mode to the normal mode in a case of receiving a control message not addressed to the third ECU, and a fourth ECU including a second PHY unit configured to switch the corresponding fourth ECU from the sleep mode to the normal mode in a case of receiving a control message regardless of a destination of the received control message, at least one third ECU being connected to the first region, and at least one fourth ECU being connected to the second region, the computer program causing a computer to execute: a first step of, in a case where a first control message, which is a control message addressed to the second ECU connected to the second region, is transmitted from the first region to the relay device, relaying the first control message to the second region; and a second step of, in a case where a second control message, which is a control message not addressed to the second ECU connected to the second region, is transmitted from the first region to the relay device, not relaying the second control message to the second region.

According to this configuration, even if the second region includes the fourth ECU that wakes up regardless of the destination of the control message, the relay device can selectively block that control message so as to not be received by the fourth ECU, thus making it possible to suppress an increase in power consumption caused by the fourth ECU waking up. Furthermore, by using the fourth ECU in conjunction with the third ECU, the implementation cost of the relay system can be reduced. As a result, in the relay system, the third ECU and the fourth ECU can be used in conjunction more favorably.

Hereinafter, details of embodiments of the present disclosure will be described with reference to the drawings.

### Configuration of Relay System

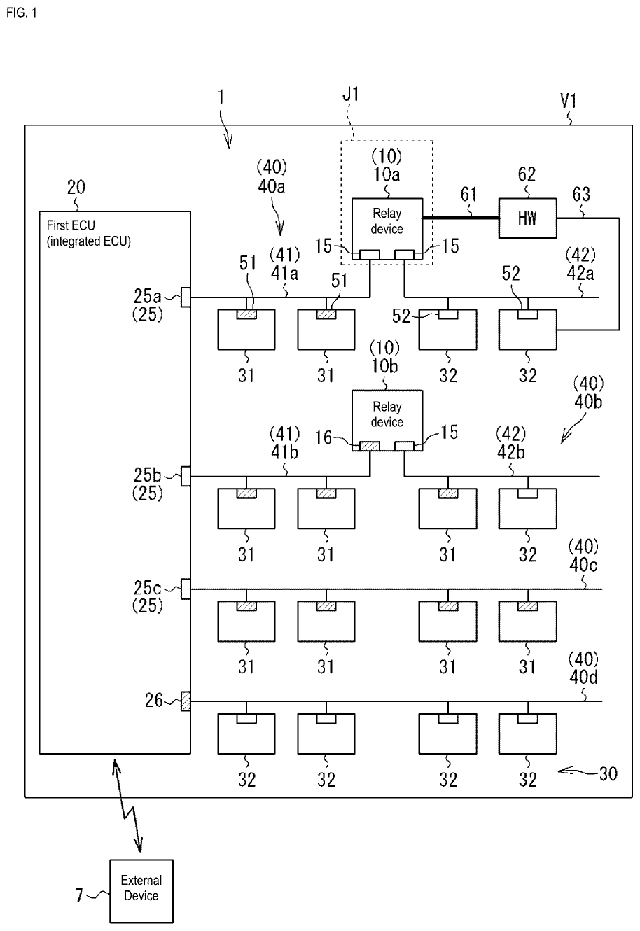

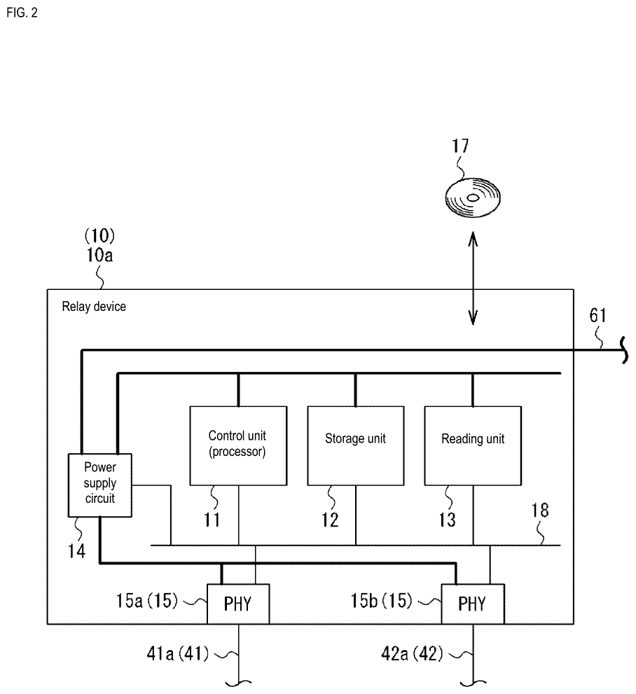

FIG. 1 is a diagram illustrating an example of the configuration of a relay system 1 according to an embodiment. In FIG. 1, thin lines connecting components of the relay system 1 represent communication lines, and thick lines connecting components of the relay system 1 represent power supply lines (this similarly applies to FIG. 2).

The relay system 1 is a system installed in a vehicle V1, which is an automobile or the like. The relay system 1 includes one or more relay devices 10, a first ECU 20, a plurality of second ECUs 30, communication lines 40, a power supply line 61, a hardware device 62, and a signal line 63.

The first ECU 20 is an electronic control unit (ECU) that relays data transmitted and received among the second ECUs 30. For example, in a network environment in which multiple local area networks (LANs) exist within the vehicle V1, the first ECU 20 may relay data transmitted and received among second ECUs 30 located on different LANs, as in the case of a central gateway (CGW).

The first ECU 20 may function as an integrated ECU that manages a plurality of second ECUs 30. For example, the first ECU 20 may distribute, to the second ECUs 30, update data downloaded from an external device 7 that is outside the vehicle V1 and connected via a network.

The external device 7 is a device installed outside the vehicle V1. For example, the external device 7 is a server that includes a control unit, a storage unit, and a communication unit. The storage unit of the external device 7 stores a program or data for controlling units of the relay system 1 (e.g., the relay devices 10, the first ECU 20, or the second ECUs 30), for example. For example, the manufacturer of one of the second ECUs 30 modifies corresponding program or data as necessary, and stores the modified program or data in the storage unit of the external device 7 as needed. The communication unit of the external device 7 transmits the modified program or data to the first ECU 20 as update data.

The communication lines 40 are communication lines connected to the first ECU 20, and extend from the first ECU 20 in a tree shape. Although four communication lines 40 extend from the first ECU 20 in the example of FIG. 1, there are no particular limitations on the number of communication lines 40. When distinguishing between the four communication lines 40, they will be referred to as communication lines 40a, 40b, 40c, and 40d, from the top to bottom in FIG. 1. The communication lines 40 are compliant with a communication protocol such as CAN (Controller Area Network), CAN-FD (CAN with Flexible Data Rate), or CAN-PN (CAN with Partial Networking).

The relay devices 10 are arranged as nodes on the communication lines 40. Although the relay system 1 shown in FIG. 1 includes two relay devices 10, there are no particular limitations on the number of relay devices 10 included in the relay system 1. When distinguishing between the two relay devices 10, the one positioned as a node on the communication line 40a will be referred to as the relay device 10a, and the one positioned as a node on the communication line 40b will be referred to as the relay device 10b.

The relay device 10a is housed in a junction box J1. The junction box J1 is a box that houses wiring, connectors, relays, and the like of devices installed in the vehicle V1. Housing the relay device 10a in the junction box J1 makes it possible to save space. Furthermore, since there is no need to prepare a separate case for housing the relay device 10a, the cost of implementation of the relay device 10a can be reduced.

The relay device 10a is a non-branching node that does not branch the communication line 40a. Specifically, the relay device 10a extends the one communication line 40a, which extends from the first ECU 20 on the parent side of the tree, as a single line to the child side of the tree. Similarly, the relay device 10b is a non-branching node that does not branch the communication line 40b. Due to the relay devices 10a and 10b being provided as non-branching nodes, it is possible to easily perform later-described data relay control, and it is also possible to simplify constituent elements of the relay devices 10a and 10b such as the later-described control unit 11, thereby making it possible to reducing the implementation cost of the relay devices 10a and 10b and suppress power consumption in the relay devices 10a and 10b.

The communication line 40a has a first region 41a on the side of the relay device 10a on which the first ECU 20 is provided, and a second region 42a on the side of the relay device 10a opposite to the first ECU 20. The communication line 40b has a first region 41b on the side of the relay device 10b on which the first ECU 20 is provided, and a second region 42b on the side of the relay device 10b opposite to the first ECU 20. Hereinafter, when not distinguishing between the first regions 41a and 41b, they will be referred to as the “first region 41” as appropriate. Also, when not distinguishing between the second regions 42a and 42b, they will be referred to as the “second region 42” as appropriate.

The second ECUs 30 are each bus-connected to corresponding communication lines 40, and are connected to the first ECU 20 via the corresponding communication lines 40. Although four second ECUs 30 are connected to each of the communication lines 40 in the example of FIG. 1, there are no particular limitations on the number of connected second ECUs 30.

Each of the second ECUs 30 is a device (operation system ECU) that controls a component of the vehicle V1 (e.g., a braking device, a door, a battery, or an air conditioner), for example. There are no particular limitations on the functions of the second ECUs 30, and the second ECUs 30 may be a device (sensing system ECU) that communicates with a sensor and monitors the state of a component of the vehicle V1. The second ECUs 30 may have different functions from each other, or may each have the same functions as each other.

The hardware device 62 is connected to the relay device 10a via the power supply line 61. Also, the hardware device 62 is connected to one of the second ECUs 30 in the second region 42a via the signal line 63. The supply of power to the hardware device 62 is normally stopped (stopped state), and, under control of the relay device 10a, power is supplied from the power supply line 61 to the hardware device 62 (supply state) only when the hardware 62 is to be used. Switching between the stopped state and the supply state is controlled by the later-described control unit 11.

The hardware device 62 is a sensor, for example. Although there are no particular limitations on the content of the sensor, the sensor may be a LiDAR (Light Detection and Ranging) for monitoring the surroundings of the vehicle V1, a sensor that detects the open/closed state of a door of the vehicle V1, a sensor that detects vibration of the vehicle V1, or a sensor that detects the temperature inside the vehicle V1, for example. In this case, the hardware device 62 transmits detection signals to the connected second ECU 30 via the signal line 63.

The hardware device 62 may be an actuator. Although there are no particular limitations on the function of the actuator, the actuator may be a brake mechanism that controls braking of the vehicle V1, an opening/closing motor that controls the opening and closing of a door of the vehicle V1, or an air conditioner that performs air conditioning in the vehicle V1, for example. In this case, the hardware device 62 receives control signals from the connected second ECU 30 via the signal line 63.

### Partial Networking in Relay System

In order to reduce the overall power consumption of the relay system 1, the relay system 1 uses a network management function to wake up only the second ECUs 30 that are to be used for control, and keep the other second ECUs 30 in the sleep state. The seconds ECU 30 can be switched between a normal mode and a sleep mode, and the switching of the modes is executed based on a control message broadcast on the communication lines 40.

The normal mode is a mode in which the second ECU 30 is woken up, and the functions of the second ECU 30 necessary for various control operations are available. For example, the normal mode is a state in which the clock circuit of a processor included in the second ECU 30 operates at a predetermined clock speed set in advance.

The sleep mode is a mode in which the functionality of the second ECU 30 is restricted to achieve lower power consumption than in the normal mode. For example, the sleep mode is a state in which the supply of power to the clock circuit of the processor included in the second ECU 30 is stopped, such that the operation of the clock circuit and the operation of the processor are stopped. Also, the sleep mode may be a state in which power is supplied to the clock circuit of the processor included in the second ECU 30, but power consumption is reduced by operating with a clock speed lower than the clock speed in the normal mode.

A control message for switching the second ECU 30 from the sleep mode to the normal mode is generated in the first ECU 20 or another one of the second ECUs 30, for example, and is broadcast to the communication lines 40. The control message includes identification information indicating the second ECU 30 that is the destination of the control message.

The second ECU 30 switches from the sleep mode to the normal mode based on the control message. Also, the second ECU 30 automatically switches from the normal mode to the sleep mode if the second ECU 30 is not used for a predetermined period of time or when a predetermined control operation is executed.

The second ECUs 30 include third ECUs 31 that include a first PHY unit 51 (ECUs that support network management functionality), and fourth ECUs 32 that include a second PHY unit 52 (ECUs that do not support network management functionality). The first PHY unit 51 and the second PHY unit 52 are both a physical layer transceiver, and include a transmission circuit, a reception circuit, and a detection circuit (none of which are shown). For example, the first PHY unit 51 and the second PHY unit 52 have the same configuration in terms of the transmission circuit and the reception circuit, but have different configurations in terms of the detection circuit.

The transmission circuit and the reception circuit perform communication compliant with a communication protocol that corresponds to the communication line 40 connected to the first PHY unit 51 or the second PHY unit 52. The transmission circuit converts data output by the corresponding second ECU 30 into a three-level signal, and sends the resulting signal to the communication line 40. The data converted into a signal is broadcast on the communication line 40. The reception circuit converts a signal received by the first PHY unit 51 or the second PHY unit 52 from the communication line 40 into data, and passes the converted data to the corresponding second ECU 30.

The first PHY unit 51 is a supporting PHY that supports the partial network function (e.g., a partial network-dedicated PHY). The detection circuit of the first PHY unit 51 has a function for determining whether or not a control message received from the communication line 40 is a control message addressed to the corresponding third ECU 31. If the received control message is a control message addressed to the corresponding third ECU 31, the corresponding third ECU 31 is switched from the sleep mode to the normal mode (in other words, the third ECU 31 is woken up).

The second PHY unit 52 is a non-supporting PHY that does not support the partial network function (e.g., a general-purpose PHY). The detection circuit of the second PHY unit 52 does not have a function for determining whether or not a control message received from the communication line 40 is a control message addressed to the corresponding third ECU 31. Upon receiving a control message from the communication line 40, the detection circuit of the second PHY unit 52 switches the corresponding fourth ECU 32 from the sleep mode to the normal mode (i.e., wakes up the fourth ECU 32) regardless of the destination of the control message.

At least one third ECU 31 is connected to the first region 41. In the example of FIG. 1, two third ECUs 31 are connected to each of the first regions 41a and 41b. Although all of the second ECUs 30 connected to the first region 41 are third ECUs 31 in FIG. 1, the second ECUs 30 connected to the first region 41 may also include a fourth ECU 32.

At least one fourth ECU 32 is connected to the second region 42. In the example of FIG. 1, two fourth ECUs 32 are connected to the second region 42a, and one fourth ECU 32 is connected to the second region 42b. The second ECUs 30 connected to the second region 42 may all be fourth ECUs 32 as in the second region 42a, or may include a third ECU 31 as in the second region 42b.

The second ECUs 30 connected to the communication line 40c are all third ECUs 31, and the second ECUs 30 connected to the communication line 40d are all fourth ECUs 32.

For example, in the case where all of the second ECUs 30 included in the relay system 1 are fourth ECUs 32, even if a certain second ECU 30 is not used for control, that second ECU 30 wakes up every time a control message addressed to another second ECU 30 is broadcast to the communication lines 40, thus unnecessarily consuming power.

On the other hand, in the case where all of the second ECUs 30 included in the relay system 1 are third ECUs 31, the second ECUs 30 each wake up only when a control message addressed thereto is received, thus making it possible to suppress power consumption in the relay system 1.

However, in this case, it is necessary to provide the first PHY unit 51 in all of the second ECUs 30. The first PHY unit 51 that supports the partial network function is often more expensive than the second PHY unit 52, and if the first PHY unit 51 is to be provided in all of the second ECUs 30, the implementation cost of the relay system 1 may increase. In particular, the number of second ECUs 30 included in a relay system such as the relay system 1 has tended to increase in recent years, and thus the number of first PHY units 51 has also increased, which may result in a more significant increase in the implementation cost of the relay system 1.

Furthermore, if both third ECUs 31 and fourth ECUs 32 are used together as second ECUs 30 in order to reduce the implementation cost of the relay system 1, a problem arises in that power consumption increases by an amount corresponding to the number of fourth ECUs 32 that are implemented, as described above. In other words, conventionally, there has been a trade-off between reducing the implementation cost of the relay system 1 and suppressing the power consumption of the relay system 1.

Therefore, in the present embodiment, the above trade-off problem is solved by inserting the relay device 10 as a node on the communication line 40 and causing the relay device 10 to function as a control message stopper. Specifically, if a control message flowing from the first region 41 toward the second region 42 is addressed to a second ECU 30 connected to the second region 42 (hereinafter referred to as a “first control message”), that control message is relayed by the relay device 10 to the second region 42. On the other hand, if a control message flowing from the first region 41 toward the second region 42 is not addressed to a second ECU 30 connected to the second region 42 (hereinafter referred to as a “second control message”), that control message is not relayed by the relay device 10 to the second region 42.

With this configuration, even if the second region 42 includes a fourth ECU 32 that wakes up regardless of the destination of a control message, the relay device 10 can selectively block that control message so as to not be received by the fourth ECU 32, thus making it possible to suppress an increase in power consumption caused by the fourth ECU 32 waking up. Furthermore, by using the fourth ECU 32 in conjunction with the third ECU 31, the implementation cost of the relay system 1 can be reduced.

In this way, by providing the relay device 10, it is possible to solve the above trade-off relationship to a certain extent. As a result, in the relay system 1, the third ECU 31 and the fourth ECU 32 can be used in conjunction more favorably. Hereinafter, the internal configurations of the relay device 10 and the first ECU 20 will be described, and then the relay method executed by the relay device 10 will be described in detail.

### Internal Configuration of Relay Device

FIG. 2 is a diagram illustrating an example of the internal configuration of the relay device 10a.

The relay device 10a includes a control unit 11, a storage unit 12, a reading unit 13, a power supply circuit 14, and two PHY units 15a and 15b. These components are electrically connected to each other by a bus 18.

The control unit 11 includes the circuit configuration (circuitry) of a processor, for example. Specifically, the control unit 11 includes one or more central processing units (CPUs). The processor included in the control unit 11 may be a graphics processing unit (GPU). In this case, the control unit 11 reads a computer program stored in the storage unit 12 and executes various type of calculation and control.

The control unit 11 may include a processor in which a predetermined program is written in advance. For example, the control unit 11 may be an integrated circuit such as a complex programmable logic device (CPLD), a field-programmable gate array (FPGA), or an application specific integrated circuit (ASIC). In this case, the control unit 11 executes various types of calculation and control based on a program written thereto in advance.

The storage unit 12 includes a volatile memory and a non-volatile memory, and stores various types of data. One example of the volatile memory is a random access memory (RAM). Examples of the non-volatile memory include a flash memory, a hard disk drive (HDD), a solid state drive (SSD), and a read only memory (ROM). For example, computer programs and various parameters are stored in the non-volatile memory of the storage unit 12.

The reading unit 13 reads information from a computer-readable recording medium 17. The recording medium 17 is an optical disk such as a CD or a DVD, or a USB flash memory, for example. The reading unit 13 is an optical drive or a USB terminal, for example. A computer program and various parameters are recorded on the recording medium 17, and by the reading unit 13 reading the recording medium 17, the computer program and various parameters are stored in the non-volatile memory of the storage unit 12.

The power supply circuit 14 is a circuit that converts power supplied from a power supply (not shown). The power converted in the power supply circuit 14 is supplied to units of the relay device 10a. The power supply circuit 14 switches on and off the supply of power to the units of the relay device 10.

The power supply line 61 extends from the power supply circuit 14, for example. The power supply circuit 14 is switched between a supply state in which power is supplied to the hardware device 62 via the power supply line 61 and a stopped state in which the supply of power to the hardware device 62 is stopped, based on a control command from the control unit 11.

The two PHY units 15a and 15b have a configuration similar to that of the second PHY unit 52 described above, and thus a description thereof will be omitted as appropriate. In other words, the two PHY units 15a and 15b are each a non-supporting PHY that does not support the partial network function, and each include a detection circuit, a transmission circuit, and a reception circuit (none of which are shown). The PHY unit 15a is connected to the first region 41a via a port (not shown). The PHY unit 15b is connected to the second region 42a via a port (not shown). The two PHY units 15a and 15b will be collectively referred to as the PHY unit 15 when there is no particular need to distinguish between them.

Similarly to the second ECU 30, the relay device 10a is normally in the sleep mode. While the relay device 10a is in the sleep mode, the supply of power from the power supply circuit 14 to the control unit 11, the storage unit 12, the reading unit 13, and the power supply line 61 is stopped.

Furthermore, while the relay device 10a is in the sleep mode, the supply of power from the power supply circuit 14 to the transmission circuit and the reception circuit of the PHY unit 15 is also stopped. On the other hand, while the relay device 10a is in the sleep mode, the power supply circuit 14 supplies power to the detection circuit of the PHY unit 15. This enables the detection circuit of the PHY unit 15 to detect control messages in the sleep mode.

Upon detecting a control message, the detection circuit of the PHY unit 15 wakes up the transmission circuit and the reception circuit of the PHY unit 15, and also wakes up the control unit 11 and the storage unit 12 in sequence. In other words, power is supplied from the power supply circuit 14 to the transmission circuit, the reception circuit, the control unit 11, and the storage unit 12. The relay device 10a thus switches from the sleep mode to the normal mode. The reading unit 13 receives power from the power supply circuit 14 when a recording medium 17 is inserted, for example.

Next, the relay device 10b will be described.

As shown in FIG. 1, the relay device 10b differs from the relay device 10a in that a third PHY unit 16 is included, and the other configurations are the same as in the relay device 10a, and thus a description of configurations that are the same will be omitted as appropriate. The relay device 10a is connected to the first region 41a and the second region 42a via PHY units 15 that do not support the partial network function.

In contrast, the relay device 10b is connected to the second region 42b via a PHY unit 15, similarly to the relay device 10a, but is connected to the first region 41b via a third PHY unit 16. The third PHY unit 16 is a supporting PHY that supports the partial network function, and has a configuration similar to that of the first PHY unit 51.

### Internal Configuration of First ECU

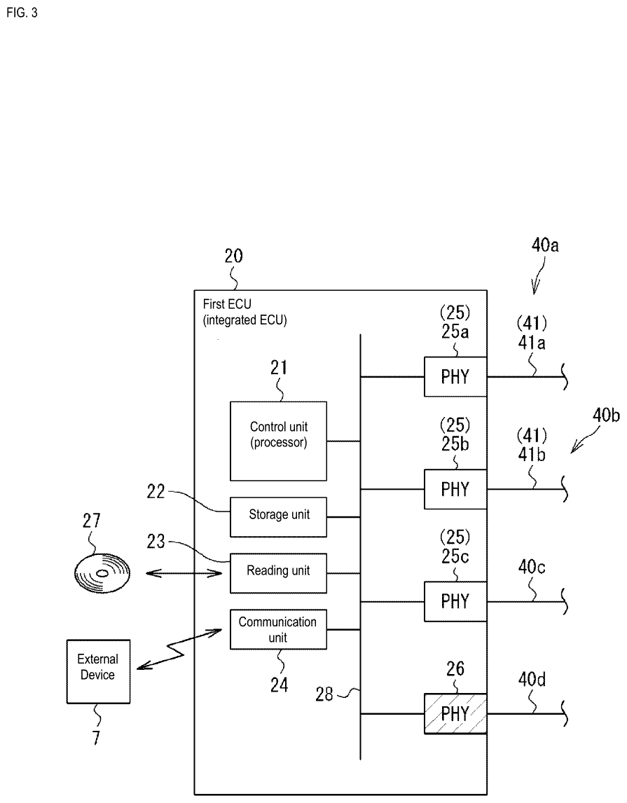

FIG. 3 is a diagram illustrating an example of the internal configuration of the first ECU 20.

The first ECU 20 includes a control unit 21, a storage unit 22, a reading unit 23, a communication unit 24, and four PHY units 25a, 25b, 25c, and 26. These units 21 to 26 are electrically connected to each other by a bus 28. The first ECU 20 further includes a power supply circuit (not shown) that converts power supplied from a power supply (not shown), and supplies the converted power to the units 21 to 26.

Similarly to the control unit 11, the control unit 21 includes the circuit configuration (circuitry) of a processor, for example. For example, the control unit 21 reads a computer program stored in the storage unit 22 and executes various type of computation and control. Similarly to the control unit 11, the control unit 21 may include a processor to which a predetermined program is written in advance. In this case, the control unit 21 executes various types of calculation and control based on the program written thereto in advance.

Similarly to the storage unit 12, the storage unit 22 includes a volatile memory and a non-volatile memory, and stores various data. For example, computer programs and various parameters are stored in the non-volatile memory of the storage unit 22.

The reading unit 23 reads information from a computer-readable recording medium 27. The recording medium 27 is an optical disk such as a CD or a DVD, or a USB flash memory, for example. The reading unit 23 is an optical drive or a USB terminal, for example. A computer program and various parameters are recorded on the recording medium 27, and by the reading unit 23 reading the recording medium 27, the computer program and various parameters are stored in the non-volatile memory of the storage unit 22.

The communication unit 24 is a communication interface that performs wireless communication with the external device 7 via a network such as the Internet. The communication unit 24 is specifically a telematics communication unit (TCU). Note that the communication unit 24 may be a communication interface separate from the TCU. In this case, the communication unit 24 may perform communication with the external device 7 via a TCU that is externally attached to the first ECU 20.

The storage unit 22 may store a computer program that is installed from the recording medium 27 via the reading unit 23, or may store a computer program that is downloaded from the external device 7 via the network and the communication unit 24.

The PHY units 25a, 25b, and 25c each have a configuration similar to that of the second PHY unit 52 (non-supporting PHY) described above, and therefore a description thereof will be omitted as appropriate. The PHY units 25a and 25b are connected to the first regions 41a and 41b via ports (not shown). The PHY unit 25c is connected to the communication line 40c via a port (not shown). These three PHY units 25a, 25b, and 25c will be collectively referred to as the PHY units 25 when there is no particular need to distinguish between them.

The PHY unit 26 has a configuration similar to that of the first PHY unit 51 (supporting PHY) described above, and therefore a description thereof will be omitted as appropriate. The PHY unit 26 is connected to the communication line 40d via a port (not shown).

The first ECU 20 is normally in the normal mode. In other words, a power supply circuit (not shown) normally supplies power to the control unit 21, the storage unit 22, the communication unit 24, and the PHY units 25 and 26. The reading unit 23 receives power from the power supply circuit when, for example, the recording medium 27 is inserted into the reading unit 23. Note that the first ECU 20 may be configured to normally be in the sleep mode and to be switched from the sleep mode to the normal mode as required, similarly to the relay device 10.

### Relay Method

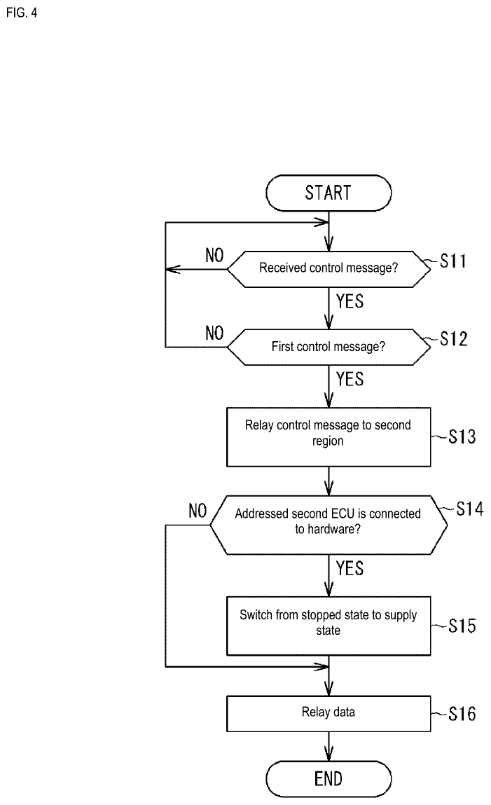

FIG. 4 is a flowchart showing an example of the relay method executed by the relay device 10. The control shown in FIG. 4 is realized by, for example, the control unit 11 reading a computer program from the storage unit 12 (or according to a program written in advance in the control unit 11) and executing various calculations and processing. Part of the control shown in FIG. 4 may be executed by the third PHY unit 16. The order of the steps shown in FIG. 4 may be changed as desired.

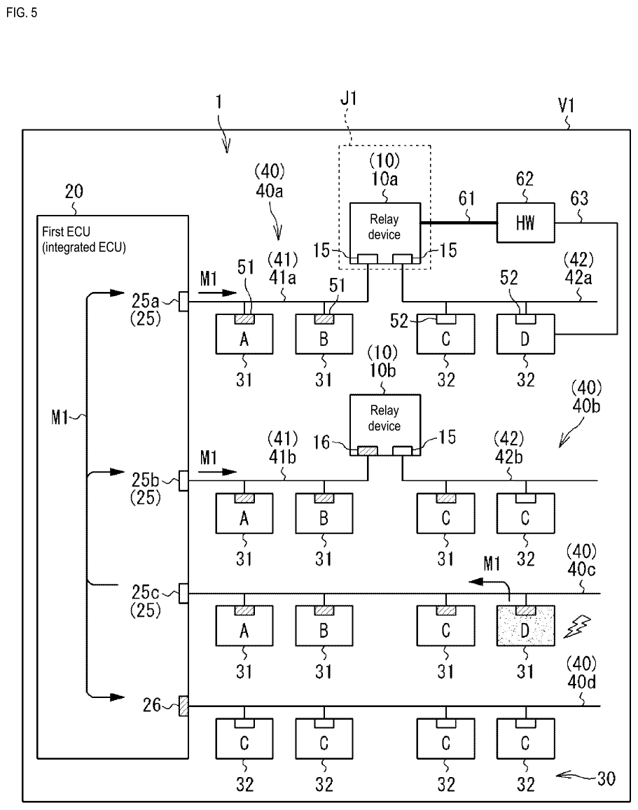

FIGS. 5 to 8 are schematic diagrams illustrating the relay method. In the following description, the relay system 1 executes partial network control to appropriately wake up a second ECU 30 to be used for control among the second ECUs 30. Each of the second ECUs 30 has an individual “activation factor”. When a predetermined activation factor occurs, the second ECU 30 that corresponds to the activation factor is woken up based on control processing described later.

Although there are no particular limitations on the types of activation factors, for the sake of convenience, four types of activation factors A to D will be described below. For example, the first activation factor A is “door of vehicle V1 was opened”. When the first activation factor A occurs, the relay system 1 wakes up the second ECUs 30 that corresponds to the first activation factor A (e.g., the ECU connected to the sensor that detects the opening and closing of the door, the ECU that controls the actuator that opens and closes the door, and the ECU that controls lighting in the vehicle V1).

The first activation factor A, the second activation factor B, the third activation factor C, and the fourth activation factor D are different factors from each other. For example, the second activation factor B is “person is in vehicle V1”, the third activation factor C is “engine of vehicle V1 is running”, and the fourth activation factor D is “vehicle V1 is traveling”. Multiple activation factors may occur in parallel. For example, if a person is riding in the vehicle V1 with the door of the vehicle V1 open, both the first activation factor A and the second activation factor B are satisfied. Note that these activation factors are merely examples, and the second ECU 30 may support other activation factors.

In the example shown in FIGS. 5 to 8, the four second ECUs 30 connected to the communication line 40a respectively support the activation factors A, B, C, and D in order from the first ECU 20 side. Also, the second ECUs 30 on the communication line 40b respectively support the activation factors A, B, C, and C in order from the first ECU 20 side; the second ECUs 30 on the communication line 40c respectively support the activation factors A, B, C, and D in order from the first ECU 20 side; and all of the second ECUs 30 on the communication line 40d support the activation factor C.

### Control Example 1

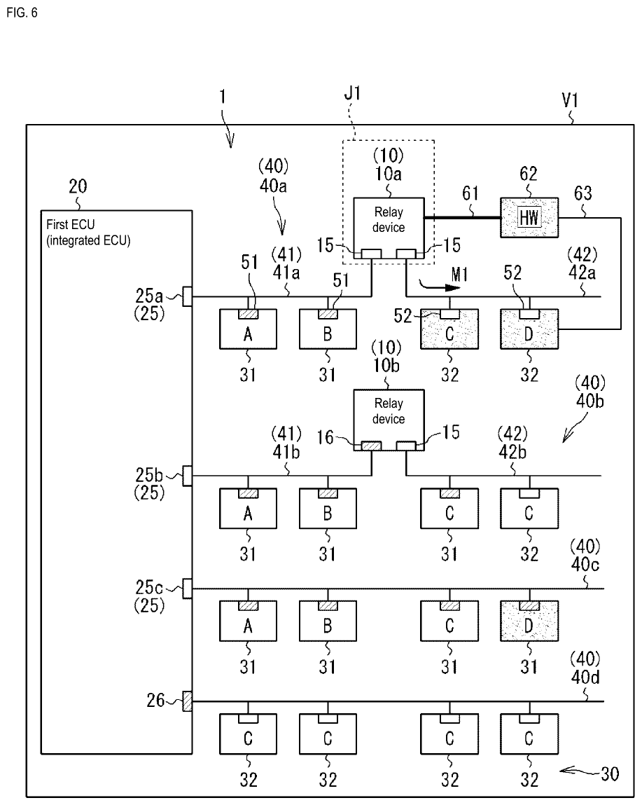

FIGS. 5 and 6 show how the second ECU 30 that supports the fourth activation factor D wakes up. As shown in FIG. 5, first, when the fourth activation factor D occurs, the second ECU 30 that is the farthest from the first ECU 20 among the second ECUs 30 on the communication line 40c wakes up on its own in response to the occurrence of the fourth activation factor D. For example, that second ECU 30 is connected to a sensor that detects the occurrence of the fourth activation factor D, and can wake up on its own without waiting for the reception of a control message generated by another second ECU 30.

After waking up, the control unit included in that second ECU 30 generates a control message M1 addressed to “second ECU 30 that supports fourth activation factor D” and broadcasts the control message M1 to the communication line 40c.

The control message M1 is transmitted via the communication line 40c to the three other second ECUs 30 connected to the communication line 40c (third ECUs 31). These three third ECUs 31 support the first to third activation factors A, B, and C, and do not support the fourth activation factor D. Therefore, the first PHY unit 51 included in each of these three third ECUs 31 determines that the control message M1 is not addressed to itself, and keeps the corresponding third ECU 31 in the sleep mode instead of switching from the sleep mode to the normal mode.

The control message M1 is received by the first ECU 20 via the PHY unit 25c, and distributed to the other PHY units 25a, 25b, and 26. The PHY units 25a and 25b do not make a determination regarding the destination of the control message M1, and thus directly transmit the control message M1 to the communication lines 40a and 40b. On the other hand, the PHY unit 26 determines that the control message M1 is not addressed to any of the second ECUs 30 connected to the communication line 40d, and does not transmit the control message M1 to the communication line 40d. Note that in the case of determining that the control message M1 is addressed to at least one of the second ECUs 30 connected to the communication line 40d, the PHY unit 26 transmits the control message M1 to the communication line 40d.

In the above example, the PHY unit 26 determines whether or not to transmit the control message M1 to the communication line 40d. This makes it possible to reduce the processing load on the control unit 21. On the other hand, the control unit 21 may determine whether or not the control message M1 is to be transmitted to the communication line 40d. For example, the control message M1 received by the first ECU 20 via the PHY unit 25c, and is input to the control unit 21. The control unit 21 distributes the control message M1 to only a communication line 40 that includes a second ECU 30 that is a destination of the control message M1. In the example of FIG. 5, the control unit 21 outputs the control message M1 to only the PHY units 25a and 25b, and does not output the control message M1 to the PHY unit 26. According to this configuration, the PHY unit 26 does not need to be a supporting PHY, and therefore the cost of implementing supporting PHYs in the relay system 1 can be reduced.

The following describes relay operations performed by the relay device 10a.

The control message M1 is transmitted from the PHY unit 25a to the first region 41a and arrives at the relay device 10a. At the same time, the control message M1 is also transmitted to the two third ECUs 31 connected to the first region 41a. The first PHY units 51 of these two third ECUs 31 determine that the control message M1 is not addressed to itself, and keep the corresponding third ECU 31 in the sleep mode instead of switching from the sleep mode to the normal mode.

FIG. 4 will be referred to below. When the PHY unit 15a of the relay device 10a receives the control message M1, the relay device 10a switches from the sleep mode to the normal mode. As a result, power is supplied to the control unit 11. The control message M1 is received by the relay device 10a via the PHY unit 15a, and is input to the control unit 11.

The control unit 11 monitors whether or not the relay device 10a has received a control message (step S11). The control unit 11 continues to perform the processing of step S11 (NO in step S11) until a control message is input to the control unit 11. If a predetermined time has elapsed without moving to the YES route in step S11, the control unit 11 switches the relay device 10a to the sleep mode in order to suppress power consumption in the relay system 1.

When a control message is input to the control unit 11 (YES in step S11), the control unit 11 then determines whether or not the control message is a first control message (a control message addressed to a second ECU 30 connected to the second region 42a) (step S12). If the control message is not the first control message (NO in step S12), the control unit 11 returns to step S11. In this way, the control unit 11 executes the determination in step S12, thus making it possible for the PHY unit 15 of the relay device 10a to have a more simple configuration. This enables reducing the implementation cost of the relay device 10a.

In this control example, the control message M1 is addressed to a second ECU 30 that supports the fourth activation factor D. Among the second ECUs 30 in the second region 42a, the second ECU 30 that is the farthest from the first ECU 20 supports the fourth activation factor D, and therefore the control message M1 is the first control message (YES in step S12).

In this case, as shown in FIG. 6, the control unit 11 relays the control message M1 to the second region 42a via the PHY unit 15b (step S13). The control message M1 is transmitted to the two fourth ECUs 32 connected to the second region 42a. The second PHY units 52 included in those fourth ECUs 32 switch the corresponding ECUs from the sleep mode to the normal mode regardless of the destination of the control message M1. Therefore, due to the control message M1, the fourth ECU 32 that supports the fourth activation factor D switches to the normal mode, and the fourth ECU 32 that supports the third activation factor C also switches to the normal mode.

According to the above operations, among the second ECUs 30 included in the relay system 1, all of the second ECUs 30 that support the fourth activation factor D switch to the normal mode.

Next, the control unit 11 determines whether or not a second ECU 30 that is a destination of the control message received in step S11 is connected to the hardware device 62 (step S14). In the case of this control example, the control message M1 is addressed to a second ECU 30 (that supports the fourth activation factor D) that is connected to the hardware device 62 via the signal line 63 (YES in step S14).

Therefore, the control unit 11 switches from the stopped state in which the supply of power to the hardware device 62 is stopped to the supply state in which power is supplied to the hardware device 62 (step S15). Specifically, the control unit 11 issues a control command to the power supply circuit 14, and the power supply circuit 14 starts supplying power to the power supply line 61.

If a second ECU 30 that is a destination of the control message received in step S11 is not connected to the hardware device 62 (NO in step S14), the control unit 11 skips step S15 and moves to step S16 described below.

After relaying the control message M1 to the second region 42a, the control unit 11 relays, to the second region 42a, data that was transmitted by the second ECU 30 that supports the fourth activation factor D on the communication line 40c and was input to the relay device 10a from the first region 41a (step S16). This data is data different from a control message, for example. In other words, the data has a purpose other than switching units included in the relay system 1 from the sleep mode to the normal mode. For example, the data is data for controlling the hardware device 62, and more specifically, data including information such as the speed of the vehicle V1, the open/closed state of a door of the vehicle V1, the temperature inside the vehicle V1, or the like.

Next, relay operations performed by the relay device 10b will be described.

The control message M1 is transmitted from the PHY unit 25b to the first region 41b and arrives at the relay device 10b. At the same time, the control message M1 is also transmitted to the two third ECUs 31 connected to the first region 41b. The first PHY units 51 of these two third ECUs 31 determine that the control message M1 is not addressed to itself, and keep the corresponding third ECU 31 in the sleep mode instead of switching from the sleep mode to the normal mode.

Next, the third PHY unit 16 of the relay device 10b monitors whether or not a control message has been received (step S11). At this point in time, the third PHY unit 16 has not yet woken up the units of the relay device 10b, and the relay device 10b remains in the sleep mode. Until later-described step S13 is started, the third PHY unit 16 maintains the relay device 10b in the sleep mode, and does not wake up the units therein.

When a control message is input to the third PHY unit 16 (YES in step S11), the third PHY unit 16 determines whether or not the input control message is the first control message (step S12). In the relay device 10a, the control unit 11 executes step S12, whereas in the relay device 10b, the third PHY unit 16 executes step S12. If the control message is not the first control message (NO in step S12), the third PHY unit 16 returns to step S11.

In this control example, the control message M1 is addressed to a second ECU 30 that supports the fourth activation factor D, and all of the second ECUs 30 included in the second region 42b support the third activation factor C, which is different from the fourth activation factor D, and therefore the control message M1 is the second control message, not the first control message. Therefore, the third PHY unit 16 returns to step S11, and the relay device 10b does not relay the control message M1 to the second region 42b. Therefore, the control message M1 does not flow to the second region 42b.

Fourth ECUs 32 that are to be woken up in response to the third activation factor C are connected to the second region 42b. If the relay device 10b is not inserted as a node on the communication line 40b, the control message M1 transmitted from the PHY unit 25b to the communication line 40b will arrive at the fourth ECUs 32 that support the third activation factor C, and will wake up those fourth ECUs 32. Those fourth ECU 32 are ECUs that are not the destination of the control message M1, and do not need to be woken up to execute the partial network function.

In this control example, the relay device 10b does not relay the control message M1 to the second region 42b (i.e., the relay device 10b functions as a stopper), thereby suppressing the waking up of the fourth ECUs 32. This makes it possible to suppress power consumption in the relay system 1.

Furthermore, in the relay device 10b, the third PHY unit 16 keeps the relay device 10b in the sleep mode (i.e., does not wake up the units of the relay device 10b) until the first control message is received from the first region 41b. Therefore, power consumption in the relay system 1 can be further suppressed.

Furthermore, in the relay device 10b, the third PHY unit 16 determines whether or not the received control message is the first control message, thus making it possible to reduce the processing load on the control unit 11. As a result, the control unit 11 can have a more simple configuration, and the implementation cost of the relay device 10b can be reduced.

### Control Example 2

Next, a second control example will be described. In the second control example, descriptions of operations the same as those in the above first control example will be omitted as appropriate.

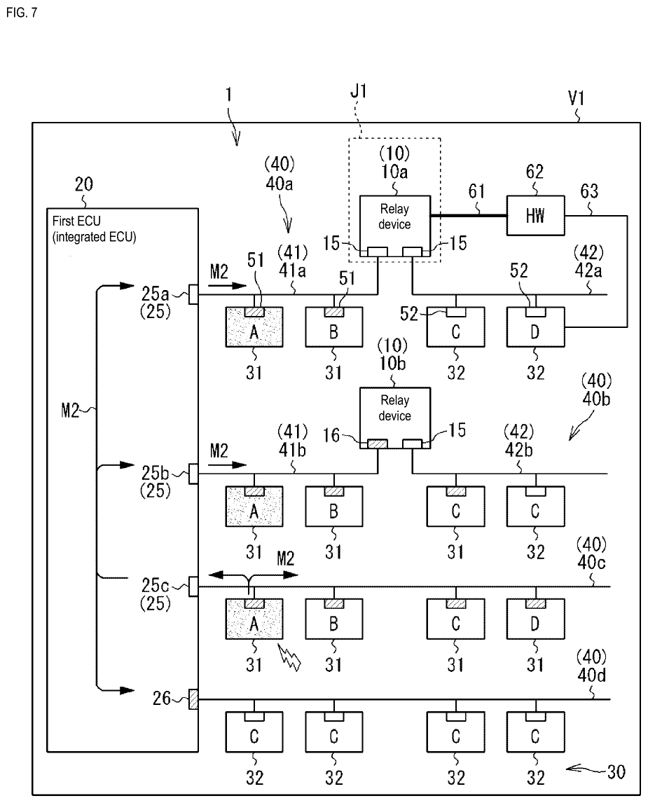

FIG. 7 shows how a second ECU 30 that supports the first activation factor A wakes up. As shown in FIG. 7, first, when the first activation factor A occurs, the second ECU 30 that is closest to the first ECU 20 on the communication line 40c wakes up on its own in response to the occurrence of the first activation factor A. After waking up, the control unit included in that second ECU 30 generates a control message M2 addressed to “second ECU 30 that supports first activation factor A” and broadcasts the control message M2 to the communication line 40c.

The control message M2 is transmitted via the communication line 40c to the three other second ECUs 30 (third ECUs 31) connected to the communication line 40c. These three third ECUs 31 support the second to fourth activation factors B, C, and D, and do not support the first activation factor A. Therefore, the first PHY unit 51 included in each of these three third ECUs 31 determines that the control message M2 is not addressed to itself, and keeps the corresponding third ECU 31 in the sleep mode instead of switching from the sleep mode to the normal mode.

The control message M2 is received by the first ECU 20 via the PHY unit 25c, and is distributed to the other PHY units 25a, 25b, and 26. The PHY units 25a and 25b do not make a determination regarding the destination of the control message M2, and thus directly transmit the control message M2 to the communication lines 40a and 40b. On the other hand, the PHY unit 26 determines that the control message M2 is not addressed to any of the second ECUs 30 connected to the communication line 40d, and does not transmit the control message M2 to the communication line 40d.

The control message M2 is transmitted from the PHY units 25a and 25b to the first regions 41a and 41b, and arrives at the relay devices 10a and 10b. At the same time, the control message M2 is also transmitted to the third ECUs 31 connected to the first regions 41a and 41b. The first PHY unit 51 included in each of the third ECUs 31 determines whether or not the control message M2 is addressed to the corresponding ECU, and if the control message M2 is addressed to the corresponding ECU, the first PHY unit 51 switches the corresponding ECU from the sleep mode to the normal mode.

In the case of this control example, on each of the communication lines 40a and 40b, the second ECU 30 closest to the first ECU 20 supports the first activation factor A, and therefore the first PHY unit 51 included in the second ECU 30 switches the corresponding ECU to the normal mode based on the control message M2. According to the above operations, among the second ECUs 30 included in the relay system 1, all of the second ECUs 30 that support the first activation factor A switch to the normal mode.

The following describes relay operations performed by the relay device 10a.

Upon receiving the control message M2, the PHY unit 15a of the relay device 10a switches the relay device 10a from the sleep mode to the normal mode. As a result, power is supplied to the control unit 11. The control message M2 is received by the relay device 10a via the PHY unit 15a, and is input to the control unit 11.

When the control message M2 is input to the control unit 11 (YES in step S11), the control unit 11 determines whether or not the control message M2 is the first control message (step S12). The control message M2 is addressed to “second ECU 30 that supports first activation factor A”, and therefore from the viewpoint of the relay device 10a, the control message M2 is the second control message and not the first control message. Therefore, the control unit 11 returns to step S11 (NO in step S12), and the relay device 10a does not relay the control message M2 to the second region 42a. Therefore, the control message M2 does not flow to the second region 42a.

Next, relay operations performed by the relay device 10b will be described.

When the control message M2 is input to the third PHY unit 16 (YES in step S11), the third PHY unit 16 determines whether or not the control message M2 is the first control message (step S12). The control message M2 is addressed to “second ECU 30 that supports first activation factor A”, and therefore from the viewpoint of the relay device 10b, the control message M2 is the second control message and not the first control message. Therefore, the third PHY unit 16 returns to step S11 (NO in step S12), and the relay device 10b does not relay the control message M2 to the second region 42b. Therefore, the control message M2 does not flow to the second region 42b.

In this way, in the case of this control example, the control message M2 does not flow to either of the second regions 42a and 42b. In other words, both of the relay devices 10a and 10b function as a control message stopper.

Multiple fourth ECUs 32 that support the third activation factor C or the fourth activation factor D are connected to the second regions 42a and 42b. If the relay devices 10a and 10b are not inserted as nodes on the communication lines 40a, 40b, the control message M2 transmitted from the PHY units 25a and 25b to the communication lines 40a and 40b will arrive at the aforementioned fourth ECUs 32, and will wake up the fourth ECUs 32. Those fourth ECU 32 are ECUs that are not the destination of the control message M2, and do not need to be woken up to execute the partial network function. In this control example, the relay devices 10a and 10b do not relay the control message M2 to the second region 42b, thus making it possible to suppress the waking up of the fourth ECUs 32. This makes it possible to suppress power consumption in the relay system 1.

### Control Example 3

Next, a third control example will be described. In the third control example, descriptions of operations the same as those in the above first control example will be omitted as appropriate.

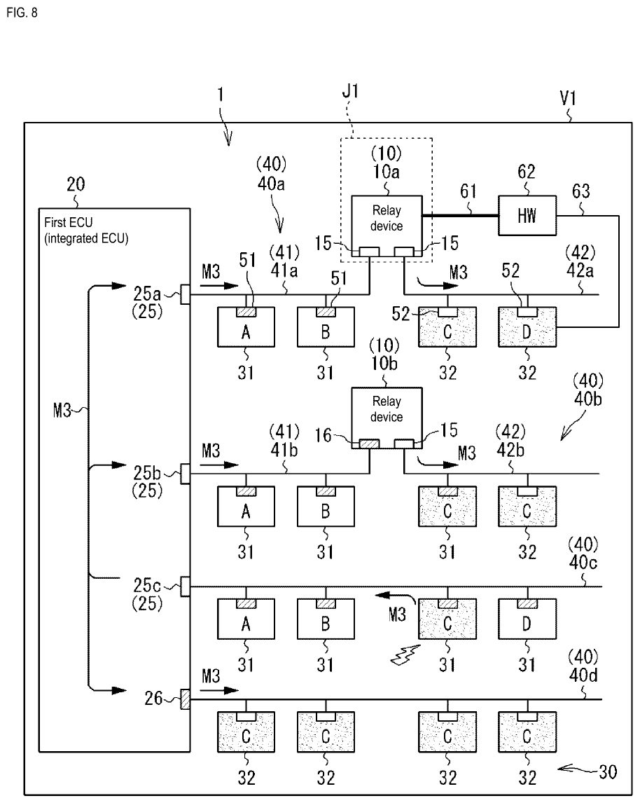

FIG. 8 shows how a second ECU 30 that supports the third activation factor C wakes up. As shown in FIG. 8, first, when the third activation factor C occurs, the second ECU 30 that is third from the first ECU 20 side of the communication line 40c wakes up on its own in response to the occurrence of the third activation factor C.

After waking up, the control unit included in that second ECU 30 generates a control message M3 addressed to “second ECU 30 that supports third activation factor C” and broadcasts the control message M3 to the communication line 40c.

The three other second ECUs 30 (third ECUs 31) connected to the communication line 40c do not support the third activation factor C. Therefore, the first PHY unit 51 included in each of these three third ECUs 31 determines that the control message M3 is not addressed to itself, and keeps the corresponding third ECU 31 in the sleep mode instead of switching from the sleep mode to the normal mode.

The control message M3 is received by the first ECU 20 via the PHY unit 25c, and distributed to the other PHY units 25a, 25b, and 26. The PHY units 25a and 25b do not make a determination regarding the destination of the control message M3, and thus directly transmit the control message M3 to the communication lines 40a and 40b. The PHY unit 26 determines that a second ECU 30 that is a destination of the control message M3 is included among the second ECUs 30 connected to the communication line 40d, and transmits the control message M3 to the communication line 40d. Upon receiving the control message M3, the second ECUs 30 connected to the communication line 40d switch from the sleep mode to the normal mode.

The control message M3 is transmitted from the PHY units 25a and 25b to the first regions 41a and 41b, and arrives at the relay devices 10a and 10b. At the same time, the control message M3 is also transmitted to the third ECUs 31 connected to the first regions 41a and 41b. The first PHY unit 51 included in each of the third ECUs 31 determines that the control message M3 is not addressed to itself, and keeps the corresponding third ECU 31 in the sleep mode instead of switching from the sleep mode to the normal mode.

The following describes relay operations performed by the relay device 10a.

Upon receiving the control message M3, the PHY unit 15a of the relay device 10a switches the relay device 10a from the sleep mode to the normal mode. As a result, power is supplied to the control unit 11. The control message M3 is received by the relay device 10a via the PHY unit 15a, and is input to the control unit 11.

When the control message M3 is input to the control unit 11 (YES in step S11), the control unit 11 determines whether or not the control message M3 is the first control message (step S12). The control message M3 is addressed to “second ECU 30 that supports third activation factor C”, and such a second ECU 30 is included in the second region 42a, and therefore from the viewpoint of the relay device 10a, the control message M3 corresponds to the first control message (YES in step S12).

In this case, as shown in FIG. 8, the control unit 11 relays the control message M3 to the second region 42a via the PHY unit 15b (step S13). The control message M3 is transmitted to the two fourth ECUs 32 connected to the second region 42a. The second PHY unit 52 included in each of these fourth ECUs 32 switches the corresponding ECU from the sleep mode to the normal mode regardless of the destination of the control message M3. Therefore, due to the control message M3, the fourth ECU 32 that supports the third activation factor C switches to the normal mode, and the fourth ECU 32 that supports the fourth activation factor D also switches to the normal mode.

Next, the control unit 11 executes step S14. In the case of this control example, a second ECU 30 that is a destination of the control message M3 is not connected to the hardware device 62 via the signal line 63 (NO in step S14). The control unit 11 skips step S15 and proceeds to step S16. As a result, the hardware device 62 is maintained in the stopped state, and therefore power consumption in the relay system 1 can be suppressed.

Next, relay operations performed by the relay device 10b will be described.

When the control message M3 is input to the third PHY unit 16 (YES in step S11), the third PHY unit 16 determines whether or not the control message M3 is the first control message (step S12). The control message M3 is addressed to “second ECU 30 that supports third activation factor C”, and therefore from the viewpoint of the relay device 10b, the control message M3 is the first control message (YES in step S12).

Therefore, the third PHY unit 16 switches the relay device 10b from the sleep mode to the normal mode, and inputs the control message M3 to the control unit 11. The control unit 11 relays the control message M3 to the second region 42b via the PHY unit 15b (step S13). The first PHY unit 51 of the third ECU 31 connected to the second region 42b determines that the control message M3 is addressed to the corresponding ECU, and switches the third ECU 31 from the sleep mode to the normal mode. Moreover, the fourth ECU 32 connected to the second region 42b switches the corresponding ECU from the sleep mode to the normal mode regardless of the destination of the control message M3.

Accordingly, among the second ECUs 30 included in the relay system 1, all of the second ECUs 30 that supports the third activation factor C switch to the normal mode.

### Modified Examples

Modified examples of the embodiment will be described below. In the modified examples, components the same as those in the above embodiment are given the same reference numerals, and descriptions thereof will be omitted.

### Relay Device as Branch Node

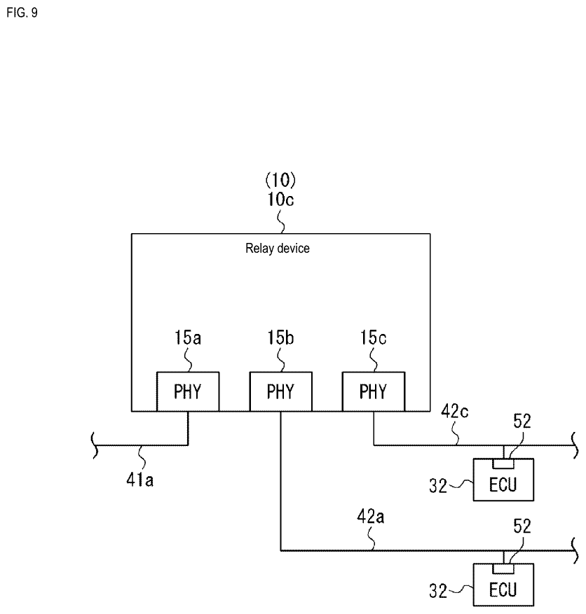

FIG. 9 is a diagram illustrating a relay device 10c and peripheral configurations thereof according to a modified example.

In the above embodiment, the relay devices 10a and 10b are both non-branching nodes that do not branch the communication lines 40a and 40b. However, the relay device is not limited to being a non-branching node. For example, a relay device 10c that is a branch node may be provided instead of the relay device 10a.

The relay device 10c includes three PHY units 15a, 15b, and 15c. The PHY units 15a, 15b, and 15c all have a configuration similar to that of the second PHY unit 52. The PHY unit 15a is connected to the first region 41a via a port (not shown), and the PHY units 15b and 15c are respectively connected to the second region 42a and a second region 42c via ports (not shown).

Specifically, the relay device 10c is a node that branches one branch (first region 41a) extending from the parent side (first ECU 20 side) into two branches (second regions 42a and 42c). Note that the relay device 10c may include four or more PHY units, and may branch the one branch extending from the parent side into three or more branches.

One or more fourth ECUs 32 are connected to each of the second regions 42a and 42c. If a first control message addressed to a fourth ECU 32 connected to the second region 42a is transmitted from the first region 41a to the relay device 10c, the control unit 11 of the relay device 10c (the configuration of the control unit 11 is similar to that in FIG. 2) relays the first control message to the second region 42a. Also, if a first control message addressed to a fourth ECU 32 connected to the second region 42c is transmitted from the first region 41a to the relay device 10c, the control unit 11 of the relay device 10c relays the first control message to the second region 42c.

If a second control message that is not addressed to a fourth ECU 32 connected to the second region 42a is transmitted from the first region 41a to the relay device 10c, the control unit 11 of the relay device 10c does not relay the second control message to the second region 42a. Also, if a second control message that is not addressed to a fourth ECU 32 connected to the second region 42c is transmitted from the first region 41a to the relay device 10c, the control unit 11 of the relay device 10c does not relay the second control message to the second region 42c.

### Relay Device in Series on Communication Line

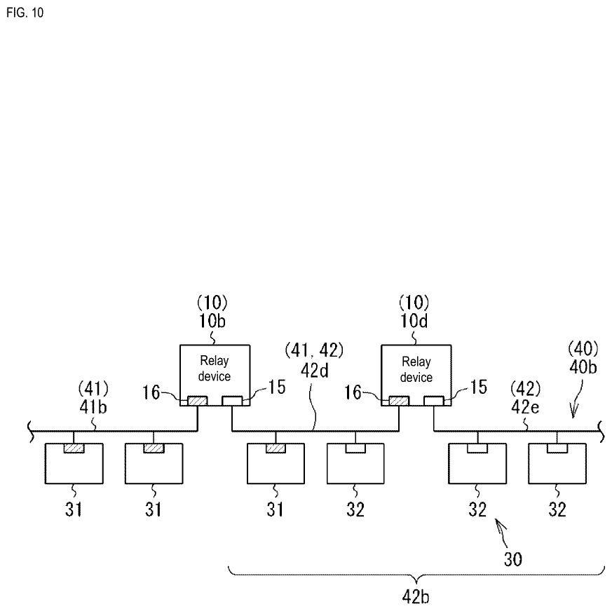

FIG. 10 is a diagram illustrating an arrangement of relay devices 10b and 10d according to a modified example.

In the example of FIG. 1, the relay devices 10a and 10b are respectively provided on the communication lines 40a and 40b. However, the relay system 1 of the present disclosure is not limited to this configuration. For example, two relay devices 10b and 10d may be provided in series on the communication line 40b. The relay device 10d is a device having a configuration similar to that of the relay device 10b.

The relay device 10d is a non-branching node inserted into the second region 42b shown in FIG. 1. The relay device 10d divides the second region 42b in FIG. 1 into a region 42d on the relay device 10b side and a region 42e on the side opposite to the relay device 10b. The third PHY unit 16 of the relay device 10d is connected to the region 42d, and the PHY unit 15 of the relay device 10d is connected to the region 42e.

Likewise to the above embodiment, from the viewpoint of the relay device 10b, the region of the communication line 40b on the first ECU 20 side of the relay device 10b (i.e., the first region 41b) is the first region 41, and the region of the communication line 40b on the side of the relay device 10b opposite to the first ECU 20 (i.e., the regions 42d and 42e) is the second region 42. On the other hand, from the viewpoint of the relay device 10d, the region of the communication line 40b on the first ECU 20 side of the relay device 10d (i.e., the first region 41b and the region 42d) is the first region 41, and the region of the communication line 40b on the side of the relay device 10d opposite to the first ECU 20 (i.e., the region 42e) is the second region 42. In other words, the region 42d is the second region 42 from the viewpoint of the relay device 10b, and is the first region 41 from the viewpoint of the relay device 10d.

For example, if a control message addressed to a second ECU 30 connected to the region 42d or the region 42e is transmitted from the first region 41b to the relay device 10b, the relay device 10b relays the control message to the region 42d. If a control message addressed to a second ECU 30 connected to the region 42e is transmitted from the region 42d to the relay device 10d, the relay device 10d relays the control message to the region 42e.

Also, if a control message that is not addressed to any of the second ECUs 30 connected to the region 42d or the region 42e is transmitted from the first region 41b to the relay device 10b, the relay device 10b does not relay the control message to the region 42d. If a control message that is not addressed to a second ECU 30 connected to the region 42e is transmitted from the region 42d to the relay device 10d, the relay device 10d does not relay the control message to the region 42e.

According to this configuration, in the relay system 1 in which both a third ECU 31 and a fourth ECU 32 are connected to the communication line 40b, it is possible to improve the degree of freedom in system design while also both reducing the cost implementing second ECUs 30 and suppressing power consumption in the second ECUs 30.

### Other Matter

In the above embodiment, the relay device 10a is housed in the junction box J1. However, the relay device 10a of the present disclosure is not limited to this configuration. For example, the relay device 10a may be housed in a second ECU 30. In this case, a configuration is possible in which, for example, the second ECU 30 is connected to the communication line 40 as a node, and the control unit included in the second ECU 30 functions not only as the control unit 11 of the relay device 10a but also functions as a control unit that performs the control originally performed by the second ECU 30.

### Supplementary Remarks

Note that at least portions of the above embodiments and various modified examples may be combined with each other as desired. Furthermore, the embodiment and modified examples disclosed herein are to be considered as illustrative in all respects and not restrictive. The scope of the present disclosure is defined by the claims, and it is intended to include all modifications within the meaning and scope of the claims.

1. A relay device to be provided in a vehicle and arranged as a node on a communication line connected to a first ECU provided in the vehicle,
the first ECU being bus-connected to a plurality of second ECUs via the communication line,
the communication line having a first region on a side of the relay device corresponding to the first ECU, and a second region on a side of the relay device opposite to the first ECU,
each of the second ECUs being switchable, based on a control message broadcast to the communication line, from a sleep mode to a normal mode, the sleep mode being a mode in which functionality is restricted to achieve lower power consumption than in the normal mode,
the second ECUs including
a third ECU including a first PHY unit configured to switch the third ECU from the sleep mode to the normal mode in a case of receiving a control message addressed to the third ECU, and to not switch the third ECU from the sleep mode to the normal mode in a case of receiving a control message not addressed to the third ECU, and
a fourth ECU including a second PHY unit configured to switch the fourth ECU from the sleep mode to the normal mode in a case of receiving a control message regardless of a destination of the received control message,
at least one third ECU being connected to the first region,
at least one fourth ECU being connected to the second region,
the relay device being configured to, in a case where a first control message, which is a control message addressed to the second ECU connected to the second region, is transmitted from the first region to the relay device, relay the first control message to the second region, and
the relay device being further configured to, in a case where a second control message, which is a control message not addressed to the second ECU connected to the second region, is transmitted from the first region to the relay device, not relay the second control message to the second region.

2. The relay device according to claim 1, comprising:
a control unit configured to determine whether or not a control message transmitted from the first region to the relay device is the first control message, and, in a case where the control message transmitted from the first region is the first control message, relay the first control message to the second region.

3. The relay device according to claim 1, comprising:
a third PHY unit configured to receive a control message transmitted from the first region to the relay device; and
a control unit configured to relay the control message output from the third PHY unit to the second region,
wherein the third PHY unit outputs the first control message to the control unit, and does not output the second control message to the control unit.

4. The relay device according to claim 2,
wherein the control unit is further configured to switch between a supply state in which power is supplied to a hardware device connected to the relay device via a power supply line, and a stopped state in which supply of power to the hardware device is stopped,
the hardware device is connected to the second ECU connected to the second region, and
the control unit switches from the stopped state to the supply state in a case where a first control message addressed to the second ECU connected to the hardware device is transmitted from the first region to the relay device.

5. The relay device according to claim 1,
wherein the relay device is a non-branching node not branching the communication line.

6. The relay device according to claim 1,
wherein the relay device is housed in a junction box.

7. A relay system comprising:
the relay device according to claim 1;
the first ECU; and
the communication line.

8. A relay method in a relay device to be provided in a vehicle and arranged as a node on a communication line connected to a first ECU provided in the vehicle,
the first ECU being bus-connected to a plurality of second ECUs via the communication line,
the communication line having a first region on a side of the relay device corresponding to the first ECU, and a second region on a side of the relay device opposite to the first ECU,
each of the second ECUs being switchable, based on a control message broadcast to the communication line, from a sleep mode to a normal mode, the sleep mode being a mode in which functionality is restricted to achieve lower power consumption than in the normal mode,
the second ECUs including
a third ECU including a first PHY unit configured to switch the third ECU from the sleep mode to the normal mode in a case of receiving a control message addressed to the third ECU, and to not switch the third ECU from the sleep mode to the normal mode in a case of receiving a control message not addressed to the third ECU, and
a fourth ECU including a second PHY unit configured to switch the corresponding fourth ECU from the sleep mode to the normal mode in a case of receiving a control message regardless of a destination of the received control message,
at least one third ECU being connected to the first region, and
at least one fourth ECU being connected to the second region,
the relay method comprising:
a first step of, in a case where a first control message, which is a control message addressed to the second ECU connected to the second region, is transmitted from the first region to the relay device, relaying the first control message to the second region; and
a second step of, in a case where a second control message, which is a control message not addressed to the second ECU connected to the second region, is transmitted from the first region to the relay device, not relaying the second control message to the second region.

9. A computer program for relaying performed by a relay device to be provided in a vehicle and arranged as a node on a communication line connected to a first ECU provided in the vehicle,
the first ECU being bus-connected to a plurality of second ECUs via the communication line,
the communication line having a first region on a side of the relay device corresponding to the first ECU, and a second region on a side of the relay device opposite to the first ECU,
each of the second ECUs being switchable, based on a control message broadcast to the communication line, from a sleep mode to a normal mode, the sleep mode being a mode in which functionality is restricted to achieve lower power consumption than in the normal mode,
the second ECUs including
a third ECU including a first PHY unit configured to switch the third ECU from the sleep mode to the normal mode in a case of receiving a control message addressed to the third ECU, and to not switch the third ECU from the sleep mode to the normal mode in a case of receiving a control message not addressed to the third ECU, and
a fourth ECU including a second PHY unit configured to switch the corresponding fourth ECU from the sleep mode to the normal mode in a case of receiving a control message regardless of a destination of the received control message,
at least one third ECU being connected to the first region, and
at least one fourth ECU being connected to the second region,
the computer program causing a computer to execute:
a first step of, in a case where a first control message, which is a control message addressed to the second ECU connected to the second region, is transmitted from the first region to the relay device, relaying the first control message to the second region; and
a second step of, in a case where a second control message, which is a control message not addressed to the second ECU connected to the second region, is transmitted from the first region to the relay device, not relaying the second control message to the second region.
